(19) United States
(12) Patent Application Publication
(10) Pub. No.: US 2015/0046903 A1
(43) Pub. Date: Feb. 12, 2015

(54) PREDICTING IMMEDIATE BUILD TARGETS

(71) Applicant: INTERNATIONAL BUSINESS MACHINES INCORPORATED, Armonk, NY (US)

(72) Inventors: Krishna K. Jain, Keshavpura (IN); Mehulkumar J. Mehta, Bangalore (IN); Gurudutt K. Vyudayagiri Jagannath, Bangalore (IN)

(21) Appl. No.: 13/960,002

(22) Filed: Aug. 6, 2013

(51) Int. Cl. G06F 9/44

(52) U.S. Cl. CPC G06F 8/70
USPC 717/120

(57) ABSTRACT

Respective dependencies are identified for each build target in a plurality of build targets. In response to scheduling a build for any build target in the plurality of build targets, determining that all dependencies for a build target in the plurality of build targets have one of the following classifications list: no build is required, built, currently being built, and ready to build, and classifying the target as available for preparatory build activities. In another aspect of the invention, each build target in the plurality of build targets that is available for preparatory build activities is classified as considered to be built. For these build targets, in response to scheduling a build for a build target in the plurality of build targets, classifying the target as available for preparatory build activities.

### FIELD OF THE INVENTION

The present invention relates generally to the field of software program development tools, and more particularly to software program development tools for preprocessing software components prior to compilation.

### BACKGROUND OF THE INVENTION

Computer programs, which may be part of a software project, are typically built from one or more sets of source files and “include” files, which require compiling into object files, then linking with software libraries. During the program creation process, modifying any one of the source files requires recompilation, or building, of that part of the program followed by relinking. This process may be automated with software engineering tools such as the “make” utility. The make utility uses a “makefile” which defines dependencies between source files and “targets,” or object files. The makefile also includes the commands required by the make utility to compile and link the files.

Each entry in the makefile is a rule expressing a target's dependencies, such as source files and other targets that are required to build a target, and the commands needed to build the target. During the build process, the make utility parses the makefile rules and determines a hierarchical dependency relationship among all of the targets and source files. If a target or source file in a target's hierarchical dependency relationships has been modified, the target is rebuilt to integrate the modification into the target. Thus, the make utility operates incrementally, in that it only regenerates a target file if one of its dependent files has changed since the last time the target was built.

Software projects can have thousands of files, resulting in extremely complex dependency structures. In addition, makefiles may be arranged in a hierarchical structure with higher-level makefiles invoking lower-level makefiles to build pieces of the software project, adding additional complexity to the build process. In practice, software projects are often periodically rebuilt from scratch, for example, nightly. This may be done, for example, to mitigate inaccuracies in a complicated makefile dependency structure and guarantee a clean build. A complete build can take several hours, and may result from a seemingly small change to a source file.

There are several build acceleration methodologies that have been implemented to reduce the time required for a build. For example, targets with dependencies that are independent of each other may be built in parallel, either on the same computer or distributing the builds to other computers in a cluster. Another methodology attempts to avoid builds by, for example, determining if a target that requires a build has been built in an independent software project. As mentioned above, inaccuracies in a complicated makefile dependency structure may reduce the effectiveness of these build acceleration methodologies.

### SUMMARY

Embodiments of the present invention disclose a method, computer program product, and system for identifying immediate build targets. Respective dependencies are identified for each build target in a plurality of build targets. In response to scheduling a build for any build target in the plurality of build targets, determining that all dependencies for a build target in the plurality of build targets have one of the following classifications list: no build is required, built, currently being built, and ready to build, and classifying the target as available for preparatory build activities. In another aspect of the invention, each build target in the plurality of build targets that is available for preparatory build activities is classified as considered to be built. For these build targets, in response to scheduling a build for a build target in the plurality of build targets, classifying the target as available for preparatory build activities.

### BRIEF DESCRIPTION OF THE SEVERAL VIEWS OF THE DRAWINGS

FIG. 1 is a dependency graph illustrating the dependencies among an exemplary set of source files and targets, in accordance with an embodiment of the present invention.

FIG. 2 illustrates a possible hierarchy of build target groupings for the exemplary set of source files and targets of FIG. 1, in accordance with an embodiment of the present invention.

FIG. 3 shows a functional block diagram of a predictive build target system, in accordance with an embodiment of the present invention.

FIG. 4 shows a functional block diagram of a make utility of the predictive build target system of FIG. 3, in accordance with an embodiment of the present invention.

FIGS. 5A, 5B, and 5C are a flowchart showing operational steps of the make utility of the predictive build target system of FIG. 3, in accordance with an embodiment of the present invention.

FIG. 6 shows a block diagram of components of a computing device of the predictive build target system of FIG. 3, in accordance with an embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk®, C++ or the like and conventional procedural programming languages, such as the “C” programming language or similar programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

The present invention will now be described in detail with reference to the figures.

As mentioned above, each entry in a makefile is a rule expressing a target's dependencies, such as source files and other targets that are required to build a target, and the commands needed to build or make that object. If any of the dependencies of the target have been modified since the last build of the target, as determined, for example, by examining timestamps in a configuration management system that controls development of the software project, then the commands in the command line, for example, build commands, are executed.

An exemplary excerpt of dependency entries of a makefile, without the associated build commands, is shown in Table 1.

TABLE 1
Makefile Excerpt - Dependency Entries

| Target | Dependencies |
|---|---|
| T1 | d1 d2 d3 |
| T2 | d2 d4 d5 |
| T3 | T2 d4 |
| T4 | T2 d1 |
| T5 | T1 T2 |
| T6 | T1 T3 T4 |
| T7 | T5 T6 d7 |
| T8 | T5 d6 |

Table 1 shows build targets, for example, targets T1, T2, etc., and each target's dependencies. In the example, source files are indicated by a “d”, for example, d1, d2, etc.

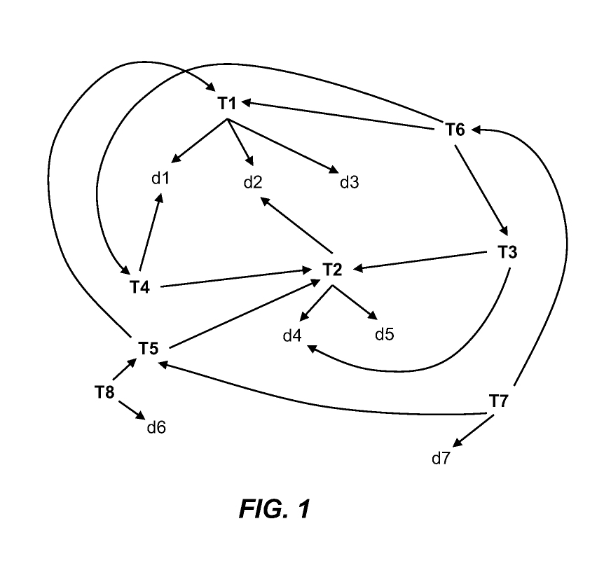

FIG. 1 is a dependency graph illustrating the dependencies among the exemplary set of source files and targets of Table 1, in accordance with an embodiment of the present invention. As shown, with the relatively few example dependency entries in Table 1, the dependencies can become complex.

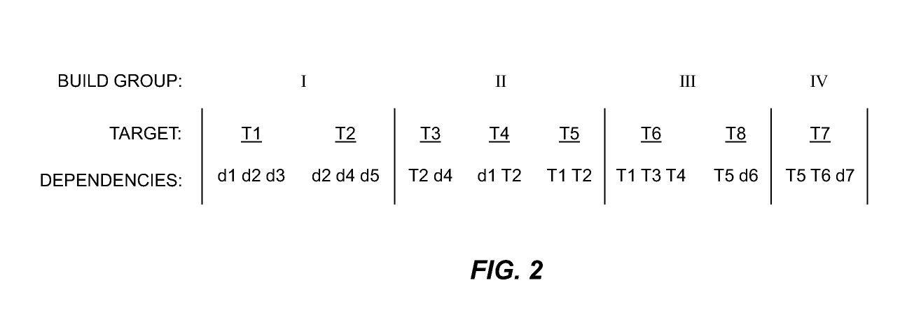

FIG. 2 illustrates a possible hierarchy of build target groupings for the exemplary set of source files and targets of Table 1, in accordance with an embodiment of the present invention. Because source files d1, d2, d3, d4, and d5 do not need to be built (notwithstanding any “inherent” dependencies, such as include files), and neither of targets T1 or T2 are in the other's dependency list, T1 and T2 can be built independently of each other, and their builds may be scheduled at the same time. As shown in FIG. 2, targets T1 and T2 are in build group I.

As shown in Table 1, targets T3 and T4 depend on target T2 and other source files, and T5 depends on both targets T1 and T2. Therefore, target T2 must be built before targets T3 and T4 are built, and both targets T1 and T2 must be built before target T5 is built. One possible way to manage the build process for the targets of Table 1 is to complete the builds of targets T1 and T2 on build group I, then schedule the builds of targets T3, T4, and T5. This is illustrated in FIG. 2 by grouping targets T3, T4, and T5 into build group II. A similar dependency analysis results in grouping targets T6 and T8 together, for example, into build group III as illustrated, and scheduling their builds when the builds of build group II completes, and scheduling the build of target T7, in build group IV, when build group III completes. Other scheduling options may also work for the makefile dependencies illustrated in Table 1. For example, the builds of T1 and T2 can be scheduled together. If T2 completes before T1, the builds of T3 and T4 can begin.

While a target's dependencies are one source for build delays, other situations can also cause delays. For example, if a source file is on a network drive, reading the file onto the computer hosting the make utility may introduce delays. In addition, source files may have implicit dependencies that can affect a build. For example, if an include file for a source file has been updated, this may require builds for all targets depending on the source file.

As mentioned above, a complete build for a software project can take several hours. An efficient way to reduce the time required to complete builds is desired. Embodiments of the present invention are directed to accelerating a build in progress by identifying targets whose builds are likely to be scheduled next, based on the immediate or pending availability of their dependencies. After these targets are identified, additional actions may be performed, such as preparatory work for build, for example, pre-fetching the source files for these targets. In this manner, such preparatory work is performed in a targeted, efficient manner.

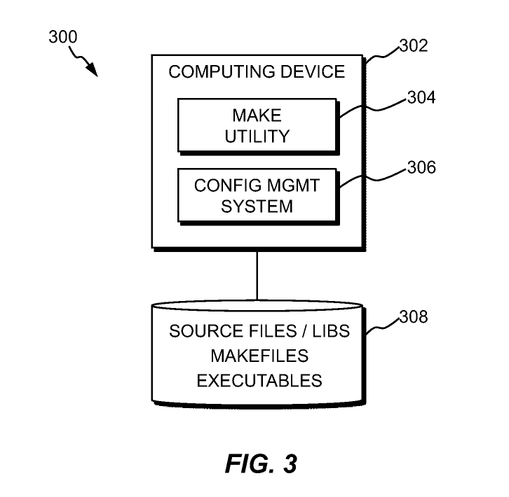

FIG. 3 shows a functional block diagram of a predictive build target system 300, in accordance with an embodiment of the present invention. Predictive build target system 300 includes computing device 302, coupled to data store 308.

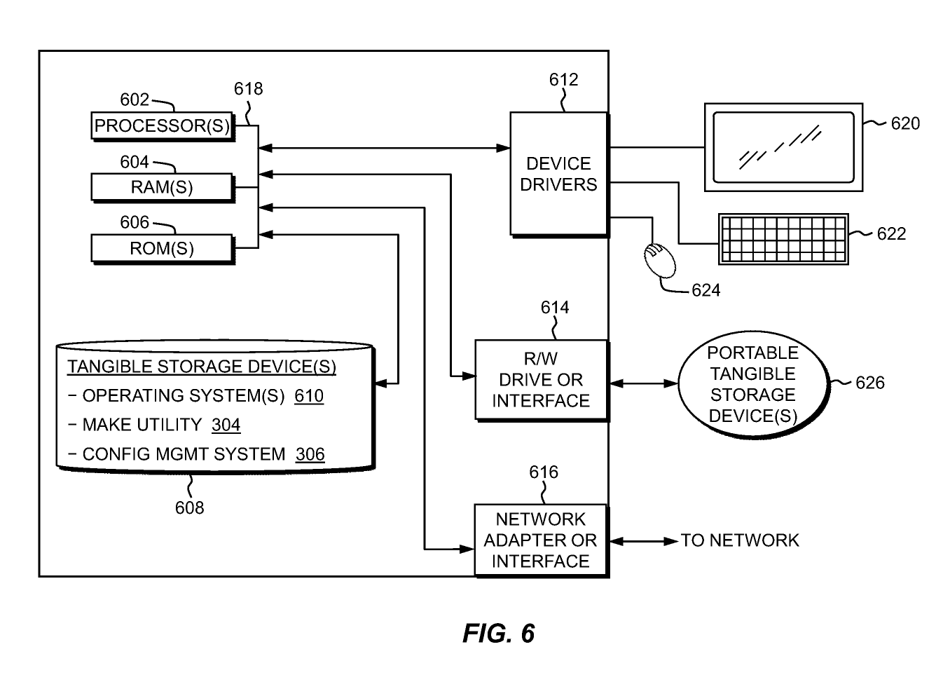

Computing device 302 represents a computing device, system, or environment that hosts make utility 304 and may include configuration management system 306. Computing device 302 may be a laptop computer, a notebook computer, a personal computer (PC), a desktop computer, a tablet computer, a thin client, or any other electronic device or computing system capable of performing the required functionality of embodiments of the invention. Computing device 302 may include internal and external hardware component, as depicted and described in further detail with respect to FIG. 6. In other various embodiments of the present invention, computing device 302 may represent a computing system utilizing clustered computers and components to act as a single pool of seamless resources.

Data store 308 represents computer-readable storage media coupled to computing device 302. Data store 308 operates to store source files, libraries, makefiles, executable object modules, and other files and libraries that may be required to support the development of a software project. Data store 308 may be a tangible storage device, such as tangible storage device(s) 608 (see FIG. 6), a network storage device, distributed storage, or any combination of these capable of performing the required functionality of embodiments of the invention.

Make utility 304, which is described in more detail below, operates to build software projects based on the makefiles, source files, libraries, executable object modules, and other files and libraries stored on data store 308, in accordance with embodiments of the invention. Make utility 304 can be any commercially available or open source make utility that directly supports, or will support, user enhancements capable of implementing the functionality of build logic module 402 and prediction logic module 404, as described below, in accordance with embodiments of the present invention.

Configuration management system 306 operates generally to support the development and version control activities for software projects under development. In particular, configuration management system 306 maintains the times of last modification for source files, include files, object files, and other program components of software projects managed by the configuration management system. In preferred embodiments, last modification times are in timestamps associated with each program component. In addition, configuration management system 306 supplies these timestamps and program components to make utility 304, as requested. Configuration management system 306 can be any commercially available or open source configuration management system that directly supports, or will support user enhancements capable of satisfying requirements of make utility 304, in accordance with embodiments of the present invention.

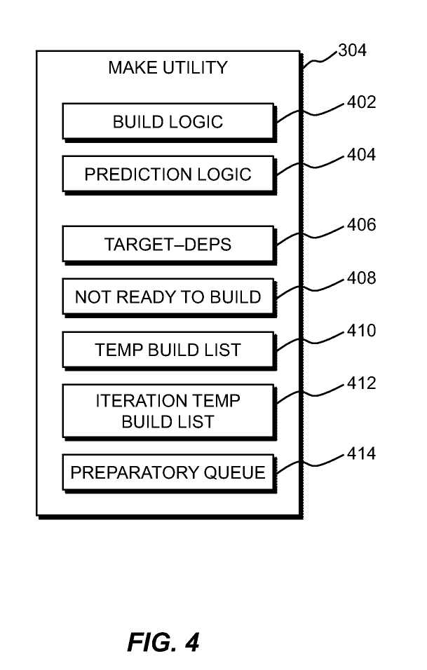

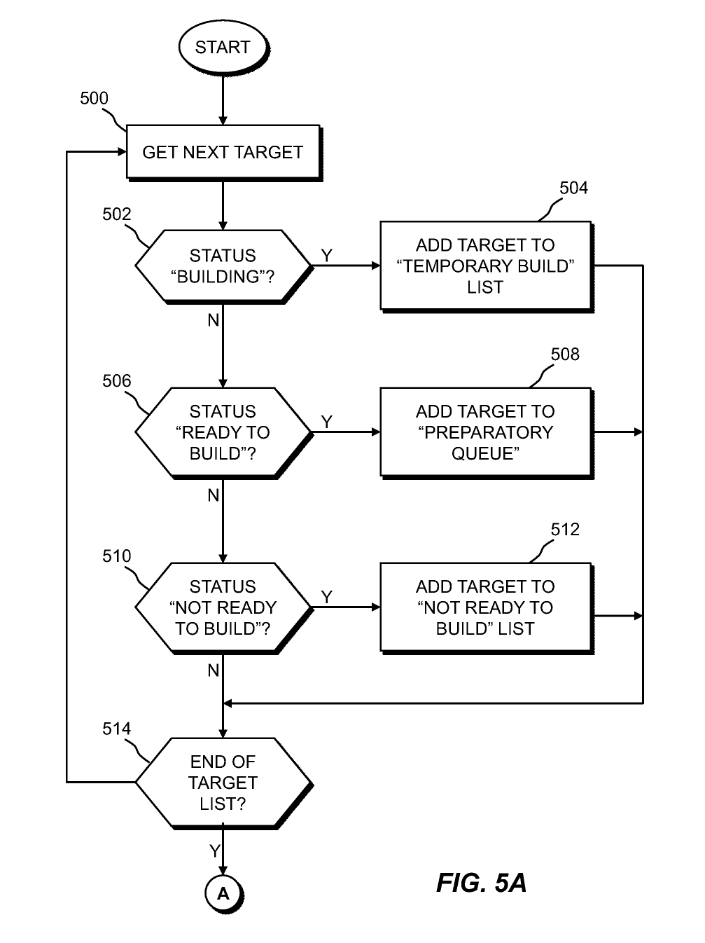

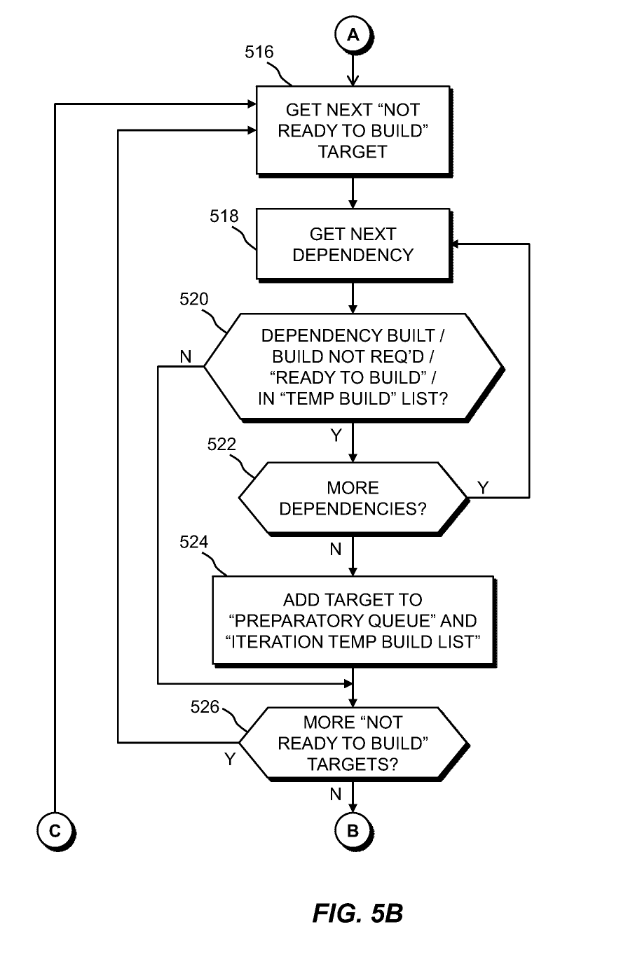

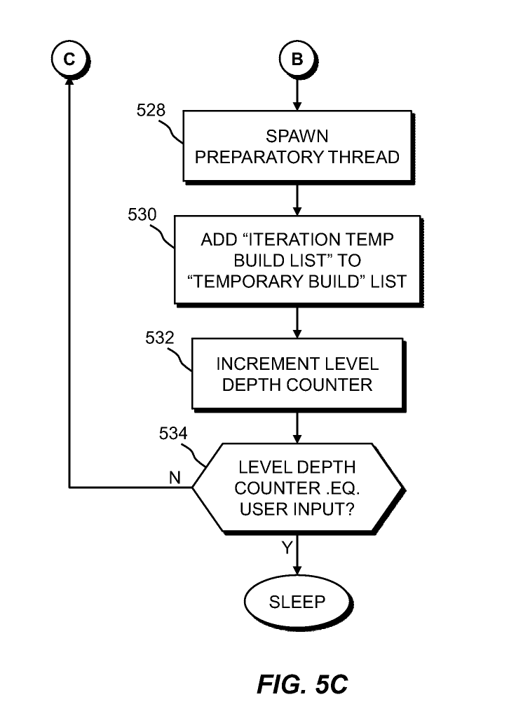

FIG. 4 shows a functional block diagram of make utility 304 of predictive build target system 300 of FIG. 3, in accordance with an embodiment of the present invention. Make utility 304 includes build logic module 402, prediction logic module 404, and several lists used by build logic module 402 and prediction logic module 404, including target-dependencies list 406, not ready to build list 408, temporary build list 410, iteration temporary build list 412, and preparatory queue 414. A detailed description of these components is presented below with respect to the flowchart of FIGS. 5A-5C.

Generally, build logic module 402 operates to read makefiles on data store 308, and build software projects from the source files, libraries, executables, and other program components on the data store, based on targets and dependencies contained in the makefiles, in accordance with embodiments of the invention. As mentioned above, build logic module 402 receives program components and their metadata, for example, timestamps, previous bill of materials, etc., on data store 308 via configuration management system 306. Build logic module 402 also provides build status, e.g., “ready to build”, “building”, etc., to prediction logic module 404. Prediction logic module 404 is triggered as each target is scheduled to build, and operates generally to parse the target list of the makefile, and identify targets whose builds are likely to be scheduled next, based on the immediate or pending availability of their dependencies, and make this list of targets available to other make utility functionality for the purpose of build acceleration.

FIGS. 5A, 5B, and 5C are a flowchart showing operational steps of make utility 304 of the predictive build target system 300 of FIG. 3, in accordance with an embodiment of the present invention. When a build is initiated, build logic module 402 parses the associated makefile from data store 308 for target entries and populates the target-dependencies list 406. For example, such a list may look similar to the entries of Table 1.

After build logic module 402 populates target-dependencies list 406 when the build is initiated, or when a target is scheduled for build while a build is in progress, prediction logic module 404 reads the first, or next, entry in the target-dependencies list (step 500). For each target entry in target-dependencies list 406, prediction logic module 404 polls build logic module 402 to determine the status of the target. If the status of the target is “building” (decision step 502, “Y” branch), an entry for the target is added to temporary build list 410 (step 504). If the status of the target is “ready to build” (decision step 506, “Y” branch), an entry for the target is added to preparatory queue 414 (step 508). If the status of the target is “not ready to build” (decision step 510, “Y” branch), an entry for the target and its dependencies is added to not ready to build list 408 (step 512). All target entries in target-dependencies list 406 are processed in this manner (step 514).

After the statuses of all targets in target-dependencies list 406 have been determined and the appropriate lists have been updated (see steps 500-514), targets with a status of “not ready to build” are examined to determine if they are now ready to build, or will be ready to build when targets currently being built complete.

When the status of the last target in target-dependencies list 406 has been determined (decision step 514, “Y” branch), prediction logic module 404 reads the first, or next, target entry in not ready to build list 408 (step 516). For each dependency for the target (see step 518), it is determined if: the dependency is built; a build is not required, for example, the dependency is a source file; the dependency is another target that is ready to build; or the dependency is in temporary build list 410, i.e., the dependency is a target that is currently being built (decision step 520).

If all dependencies of a target in not ready to build list 408 are: built; a build is not required; another target that is ready to build; or in temporary build list 410 (decision step 520, “Y” step; decision step 522, “N” branch), then the target is added to preparatory queue 414, and also iteration temp build list 412 (step 524). If there are additional targets in not ready to build list 408 (decision step 526, “Y” branch), the next target is processed (step 516).

If a dependency is not one of: built; a build is not required; another target that is ready to build; or in temporary build list 410 (decision step 520, “N” branch); then, its target is not currently ready for build, and will not be ready for build when the current targets being built complete. In this case, if there are additional targets in not ready to build list 408 (decision step 526, “Y” branch), the next target is processed (step 516).

After all targets, and their dependencies, in not ready to build list 408 have been processed (decision step 526, “N” branch), in an exemplary embodiment, for each target in preparatory queue 414, prediction logic module 404 spawns a preparatory thread (step 528) that, for example, pre-fetches all the dependencies of each of these targets, including processing any includes in any source file dependencies. Preparatory queue 414 is then cleared. In addition, the targets that were added to iteration temp build list 412 are added to temporary build list 410 (step 530), and iteration temp build list 412 is cleared.

In the exemplary embodiment, in each iteration, prediction logic module 404 identifies targets in not ready to build list 408 that will be ready to build when the targets considered as currently being built (i.e., those targets in temp build list 410) complete. These identified targets are written to iteration temp build list 412. If another iteration is desired, the targets in iteration temp build list 412 are written to temp build list 410, and, for the next iteration, these targets will be considered as built.

At this point, an iteration for prediction logic module 404 is complete. A level depth counter is incremented (step 532) and the level depth counter is compared against a user input that indicates how many iterations of analysis are desired to identify potential targets for which preparatory threads may be spawned. If additional iterations are desired (decision step 534, “N” branch) a new iteration begins (step 516). If all desired iterations have completed (decision step 534, “Y” branch), temporary build list 410 and not ready to build list 408 are cleared, and prediction logic module 404 is put into a suspended or sleep state. When the next target in target-dependencies list 406 is scheduled, prediction logic module 404 is triggered, and a new analysis begins (step 500). In this manner, preparatory work, such as pre-fetching, may be initiated for targets that are likely to be scheduled next. Because prediction logic module 404 is triggered as each target in target-dependencies list 406 is scheduled, identification of targets that are likely to be scheduled next takes into account builds as they occur.

FIG. 6 depicts a block diagram of components of computing device 302 of predictive build target system 300 of FIG. 3, in accordance with an embodiment of the present invention. It should be appreciated that FIG. 6 provides only an illustration of one implementation and does not imply any limitations with regard to the environments in which different embodiments may be implemented. Many modifications to the depicted environment may be made.

Computing device 302 can include one or more processors 602, one or more computer-readable RAMs 604, one or more computer-readable ROMs 606, one or more tangible storage devices 608, device drivers 612, read/write drive or interface 614, network adapter or interface 616, all interconnected over a communications fabric 618. Communications fabric 618 can be implemented with any architecture designed for passing data and/or control information between processors (such as microprocessors, communications and network processors, etc.), system memory, peripheral devices, and any other hardware components within a system.

One or more operating systems 610, make utility 304, and configuration management system 306, are stored on one or more of the computer-readable tangible storage devices 608 for execution by one or more of the processors 602 via one or more of the respective RAMs 604 (which typically include cache memory). In the illustrated embodiment, each of the computer-readable tangible storage devices 608 can be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Computing device 302 can also include a R/W drive or interface 614 to read from and write to one or more portable computer-readable tangible storage devices 626. Make utility 304 and configuration management system 306 on computing device 302 can be stored on one or more of the portable computer-readable tangible storage devices 626, read via the respective R/W drive or interface 614 and loaded into the respective computer-readable tangible storage device 608.

Computing device 302 can also include a network adapter or interface 616, such as a TCP/IP adapter card or wireless communication adapter (such as a 4G wireless communication adapter using OFDMA technology). Make utility 304 and configuration management system 306 on computing device 302 can be downloaded to the computing device from an external computer or external storage device via a network (for example, the Internet, a local area network or other, wide area network or wireless network) and network adapter or interface 616. From the network adapter or interface 616, the programs are loaded into the computer-readable tangible storage device 608. The network may comprise copper wires, optical fibers, wireless transmission, routers, firewalls, switches, gateway computers and/or edge servers.

Computing device 302 can also include a display screen 620, a keyboard or keypad 622, and a computer mouse or touchpad 624. Device drivers 612 interface to display screen 620 for imaging, to keyboard or keypad 622, to computer mouse or touchpad 624, and/or to display screen 620 for pressure sensing of alphanumeric character entry and user selections. The device drivers 612, R/W drive or interface 614 and network adapter or interface 616 can comprise hardware and software (stored in computer-readable tangible storage device 608 and/or ROM 606).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Based on the foregoing, a computer system, method and program product have been disclosed for a presentation control system. However, numerous modifications and substitutions can be made without deviating from the scope of the present invention. Therefore, the present invention has been disclosed by way of example and not limitation.

What is claimed is:

1. A method for identifying immediate build targets, the method comprising:
identifying, by one or more processors, respective dependencies for each build target in a plurality of build targets;
in response to scheduling a build for any build target in the plurality of build targets, determining, by one or more processors, that all dependencies for a build target in the plurality of build targets have one of the classifications in the following classifications list: no build is required, built, currently being built, and ready to build; and
classifying the target as available for preparatory build activities.

2. A method in accordance with claim 1, further comprising:
classifying, by one or more processors, each build target in the plurality of build targets that is available for preparatory build activities as considered to be built;
and wherein the classifications list further includes: considered to be built.

3. A method in accordance with claim 1, wherein a dependency is ready to build if all dependencies of the dependency are one of: no build is required, and built.

4. A method in accordance with claim 1, wherein preparatory build activities include pre-fetching dependencies of a target.

5. A computer program product for identifying immediate build targets, the method comprising:
one or more computer-readable storage media and program instructions stored on the one or more computer-readable storage media, the program instructions comprising:
program instructions to identify respective dependencies for each build target in a plurality of build targets;
program instructions, in response to scheduling a build for any build target in the plurality of build targets, to determine that all dependencies for a build target in the plurality of build targets have one of the classifications in the following classifications list: no build is required, built, currently being built, and ready to build; and
program instructions to classify the target as available for preparatory build activities.

6. A computer program product in accordance with claim 5, further comprising:
program instructions to classify each build target in the plurality of build targets that is available for preparatory build activities as considered to be built; and
and wherein the program instructions defining the classifications list further includes program instructions to define: considered to be built.

7. A computer program product in accordance with claim 5, wherein a dependency is ready to build if all dependencies of the dependency are one of: no build is required, or built.

8. A computer program product in accordance with claim 5, wherein preparatory build activities include pre-fetching dependencies of a target.

9. A computer program system for identifying immediate build targets, the method comprising:
one or more computer processors, one or more computer-readable storage media, and program instructions stored on one or more of the computer-readable storage media for execution by at least one of the one or more processors, the program instructions comprising:
program instructions to identify respective dependencies for each build target in a plurality of build targets;
program instructions, in response to scheduling a build for any build target in the plurality of build targets, to determine that all dependencies for a build target in the plurality of build targets have one of the classifications in the following classifications list: no build is required, built, currently being built, and ready to build; and
program instructions to classify the target as available for preparatory build activities.

10. A computer program system in accordance with claim 9, further comprising:
program instructions to classify each build target in the plurality of build targets that is available for preparatory build activities as considered to be built; and
and wherein the program instructions defining the classifications list further includes program instructions to define: considered to be built.

11. A computer program system in accordance with claim 9, wherein a dependency is ready to build if all dependencies of the dependency are one of: no build is required, or built.

12. A computer program system in accordance with claim 9, wherein preparatory build activities include pre-fetching dependencies of a target.
